(19) United States
(12) Patent Application Publication
(10) Pub. No.: US 2012/0218852 A1
(43) Pub. Date: Aug. 30, 2012

(54) DEVICE, FLOTATION MACHINE EQUIPPED THEREWITH, AND METHODS FOR THE OPERATION THEREOF

(76) Inventors: Norbert Becker, Rottenbach (DE); Wolfgang Krieglstein, Nurnberg (DE)

(21) Appl. No.: 13/498,879

(22) PCT Filed: Sep. 28, 2010
(86) PCT No.: PCT/EP2010/064366

§ 371 Date: Apr. 27, 2012

(30) Foreign Application Priority Data
Sep. 29, 2009 (EP) 09171568.0

(51) Int. Cl. B03D 1/24; B01F 5/04; B01F 3/04

(52) U.S. Cl. 366/101; 261/42

(57) ABSTRACT

A device for dispersing a suspension with at least one gas includes a dispersion nozzle, which, viewed in the flow direction of the suspension, successively comprises: a suspension nozzle tapering in the flow direction; a mixing chamber into which the suspension nozzle leads; a mixing tube that adjoins the mixing chamber and is tapered in the flow direction; and at least one gas supply line for supplying the at least one gas into the mixing chamber, the suspension nozzle comprising at least a quantity of N=3 gas channels connected to the at least one gas supply line, said gas channels leading to an end face of the suspension nozzle facing the mixing chamber. The device may further include a number A of gas valves, where N=A, wherein a gas control valve is associated with each gas channel for metering a gas volume of the gas supplied to the suspension through the respective gas channel. A flotation machine comprising such a device and methods for operating the device and flotation machine are also provided.

### CROSS-REFERENCE TO RELATED APPLICATIONS

This application is a U.S. National Stage Application of International Application No. PCT/EP2010/064366 filed Sep. 28, 2010 which designates the United States of America, and claims priority to EP Patent Application No. 09171568.0 filed Sep. 29, 2009. The contents of which are hereby incorporated by reference in their entirety.

### TECHNICAL FIELD

This disclosure relates to a device for dispersing a suspension containing at least one gas, in particular for a flotation machine, said device comprising a dispersion nozzle, which, viewed in the flow direction of the suspension, successively comprises a suspension nozzle tapering in the flow direction, a mixing chamber into which the suspension nozzle leads, a mixing tube adjoining the mixing chamber and tapering in the flow direction, and at least one gas supply line for feeding the at least one gas into the mixing chamber, wherein the suspension nozzle has at least a number N 3 of gas ducts connected to the at least one gas supply line, said gas ducts opening out at an end face of the suspension nozzle facing the mixing chamber. The disclosure also relates to a method for operating such a device.

The disclosure furthermore relates to a flotation machine equipped with at least one device of said type, to a method for operating the flotation machine and to a use thereof.

### BACKGROUND

Flotation is a physical separation process for separating fine-grained solid mixtures, such as of ores and gangue for example, in an aqueous slurry or suspension with the aid of air bubbles on the basis that the particles contained in the suspension possess a different surface wettability. Flotation is employed for conditioning natural resources found in the earth and in the processing of preferably mineral substances having a low to medium content of a usable component or a valuable resource, for example in the form of nonferrous metals, iron, rare earth metals and/or noble metals as well as non-metallic natural resources.

Flotation machines are already well-known. WO 2006/069995 A1 describes a flotation machine having a housing comprising a flotation chamber, with at least one dispersion nozzle, referred to here as an ejector, also with at least one gas injection device, called aeration devices or aerators when air is used, as well as a collecting tank for a foam product formed in the course of the flotation process.

In flotation or pneumatic flotation, a suspension composed of water and fine-grained solid matter to which reagents have been added is generally injected into a flotation chamber by way of at least one dispersion nozzle. The effect intended to be achieved by the reagents is that in particular the valuable particles in the suspension that are to be separated by preference are rendered hydrophobic. Simultaneously with the suspension, the at least one dispersion nozzle is supplied with gas, in particular air or nitrogen, which comes into contact with the hydrophobic particles in the suspension. Further gas is introduced by means of a gas injection device. The hydrophobic particles adhere to gas bubbles that form, such that the gas bubble structures, also referred to as aeroflocks, float to the top and form the foam product at the surface of the suspension. The foam product is discharged into a collecting tank and typically also thickened.

It has been shown that the quality of the foam product or the degree of success of the flotation separation method or pneumatic flotation separation method is dependent inter alia on the collision probability between a hydrophobic particle and a gas bubble. The higher the collision probability, the greater are the number of hydrophobic particles that will adhere to a gas bubble, ascend to the surface and form the foam product together with the particles. The collision probability is in this case influenced inter alia by the dispersion of suspension and gas in the dispersion nozzle.

Dispersion nozzles according to FIG. 1 are already used in flotation machines or hybrid flotation cells of the applicant. FIG. 2 shows a longitudinal section through the dispersion nozzle 1 in which the flow profile of suspension 2 and gas 7 are respectively shown. Viewed in the flow direction (see arrow direction) of the suspension 2, this known dispersion nozzle 1 successively comprises a suspension nozzle 3 tapering in the flow direction, a mixing chamber 4 into which the suspension nozzle 3 leads, a mixing tube 5 adjoining the mixing chamber 4 and tapering in the flow direction, and at least one gas supply line 6 for feeding the at least one gas 7 into the mixing chamber 4. The suspension 2 is injected into the suspension nozzle 3 via an adapter fitting 9 and enters the mixing chamber 4 at the end face 3a of the suspension nozzle 3 as an open jet 8. The gas 7 injected into the mixing chamber 4 is mixed with the suspension 2 emerging from the suspension nozzle 3 and passes into the mixing tube 5, where a further dispersion of suspension 2 and gas 7 takes place. A suspension 2 dispersed with the gas 7 is present at the outlet port 1a from the dispersion nozzle 1.

A dispersion nozzle 1 of said kind is already used in a flotation machine 100 having a per se known design according to FIG. 20, the installation typically being carried out in such a way that the longitudinal axis of the dispersion nozzle 1 is aligned horizontally. The flotation machine 100 comprises a housing 101 having a flotation chamber 102 into which leads at least one dispersion nozzle 1 for injecting gas 7 and suspension 2 into the flotation chamber 102. The housing 101 has a cylindrical housing section 101a at the bottom end of which at least one gas injection arrangement 103 is disposed.

Inside the flotation chamber 102 there is a foam trough 104 with connecting piece 105 for discharging the formed foam product. The top edge of the outer wall of the housing 101 is located above the top edge of the foam trough 104, thus ruling out the possibility that the foam product will overflow over the top edge of the housing 101. The housing 101 also has a bottom discharge port 106. Particles of the suspension 2 which are provided for example with an insufficiently hydrophobized surface or which have not collided with a gas bubble, as well as hydrophilic particles, sink in the direction of the bottom discharge port 106. Additional gas 7 is blown into the cylindrical housing section 101a by means of the gas injection device 103 which is connected to a gas supply line 103a with the result that further hydrophobic particles are bound thereto and rise to the surface. In the ideal case the hydrophilic particles in particular continue to descend and are removed from the process by way of the bottom discharge port 106. The foam product passes out of the flotation chamber 102 into the foam trough 104 and is discharged by way of the connecting pieces 105 and thickened if necessary.

In this case the process of ingesting the gas 7 into the suspension 2 in the dispersion nozzle 1 is subject to a certain randomness in terms of continuity, with the result that the dispersion result at the outlet port la from the dispersion nozzle 1 fluctuates. A volume of gas 7 supplied by way of the at least one gas supply line 6 can be controlled simply by connecting gas control valves upstream thereof, thereby influencing the pressure conditions in the mixing chamber 4 are and as a consequence modifying the dispersion result in turn.

Finally, the arrangement of the at least one gas supply line 6 may play an important role in relation to the dispersion result. In the known dispersion nozzle 1 according to FIGS. 1 and 2, the gas supply line 6 can in principle be arranged at any position on the circumference of the mixing chamber 4. However, in order to prevent a gas supply line 6 from becoming blocked by particles of solid matter from the suspension 2, the content of which in the suspension 2 may be as much as 50 mol-%, a gas supply line 6 is preferably arranged in the upper region of the mixing chamber 4 of the horizontally aligned dispersion nozzle 1. On the other hand, this can lead to the formation of a single large gas bubble due to the buoyant force, in particular when low volumes of gas 7 are supplied or when the gas 7 is supplied at a low gas pressure, said gas bubble separating out in the upper region of the mixing chamber 4 and proving difficult to mix into the suspension 2.

The unexamined German application No. 27 000 49 discloses a dispersion nozzle for a flotation machine in which a water flow containing contaminants to be separated out is dispersed by means of air. In this case the air is induced into a rotary motion by means of a spiral-shaped air chamber.

Dispersion nozzles for flotation processes based on the design cited above, in which the suspension nozzle has gas ducts which open out at the end face of the suspension nozzle, are known from DE 42 06 715 A1 for example.

### SUMMARY

In one embodiment, a device for dispersing a suspension containing at least one gas, in particular for a flotation machine, said device comprising a dispersion nozzle which, viewed in the flow direction of the suspension, successively comprises
a suspension nozzle tapering in the flow direction;
a mixing chamber into which the suspension nozzle leads;
a mixing tube adjoining the mixing chamber and tapering in the flow direction, and
at least one gas supply line for feeding the at least one gas into the mixing chamber, wherein the suspension nozzle has at least a number N 3 of gas ducts connected to the at least one gas supply line, said gas ducts opening out at an end face of the suspension nozzle facing the mixing chamber,

wherein

the device additionally has a number A of gas valves, where N=A, wherein one gas control valve for metering a gas volume of the gas supplied to the suspension through the respective gas duct is associated with each of the at least N gas ducts.

In a further embodiment, at least one pressure water conduit is present for injecting water containing a volume of gas dissolved therein, at least some of which gas escapes in the mixing chamber, into the suspension nozzle and/or into the mixing tube. In a further embodiment, the at least one pressure water conduit is routed through a wall of the suspension nozzle and/or of the mixing tube. In a further embodiment, at least one pressure water conduit is routed into the mixing chamber and opens out at a point inside the mixing tube which adjoins a surface of an open jet developing from the end face of the suspension nozzle in the direction of the mixing tube and comprising the suspension. In a further embodiment, the suspension nozzle is provided with at least one device which is able to induce the suspension into spiral-like rotation around a longitudinal central axis of the suspension nozzle. In a further embodiment, the at least one device comprises at least one groove which is arranged at an inside face of the suspension nozzle facing the suspension and which extends in a spiral shape from a side of the suspension nozzle facing away from the mixing chamber to the end face of the suspension nozzle facing the mixing chamber. In a further embodiment, the at least one device comprises at least one ridge which is arranged at an inside face of the suspension nozzle facing the suspension and which extends in a spiral shape from a side of the suspension nozzle facing away from the mixing chamber to the end face of the suspension nozzle facing the mixing chamber. In a further embodiment, the suspension nozzle has at least a number N≧8 of gas ducts. In a further embodiment, viewed in the direction of the end face of the suspension nozzle, the N gas ducts are arranged centered at a uniform distance from one another on at least one circular path around the longitudinal central axis of the suspension nozzle.

In another embodiment, a method for operating a device as disclosed above is provide, wherein the gas control valves associated with the at least N gas ducts are operated in a clocked mode in such a way that at any given instant in time at least one gas duct is closed and at least one further gas duct is open, the gas supply to the suspension being interrupted temporarily at each gas duct in accordance with a gassing pattern M.

In a further embodiment, the gas control valves are regulated for supplying a maximum volume of gas to the suspension in such a way that only one gas duct is closed at any given instant in time, the gas supply to the suspension being temporarily interrupted at each of the gas ducts in turn in accordance with a first gassing pattern M1. In a further embodiment, the gas control valves are regulated for supplying a minimum volume of gas to the suspension in such a way that only one gas duct is open at any given instant in time, the gas being supplied to the suspension temporarily through each gas duct in turn in accordance with a second gassing pattern M2. In a further embodiment, the second gassing pattern M2 is embodied in such a way that, viewed in the direction of the end face of the suspension nozzle, the at least one gas is supplied in turn through gas ducts arranged adjacent to one another. In a further embodiment, the gassing pattern M is embodied in such a way that, viewed in the direction of the end face of the suspension nozzle, the at least one gas is supplied in turn through adjacent groups of gas ducts arranged adjacent to one another. In a further embodiment, a subset of the N gas ducts is supplied with a first gas by way of a first gas supply line and the remaining gas ducts are supplied by way of a second gas supply line with a second gas that is different from the first gas.

In yet another embodiment, a flotation machine comprising at least one device as disclosed above is provided. In a further embodiment, the flotation machine comprises a housing having a flotation chamber into which leads the dispersion nozzle of the at least one device, as well as at least one gas injection arrangement for further feeding of gas into the flotation chamber and arranged in the flotation chamber below the dispersion nozzle(s). In yet another embodiment, a method for operating such a flotation machine is provided, wherein the suspension is injected into the flotation chamber by means of the dispersion nozzle and in that the device is operated as disclosued above, with gas being supplied to the mixing chamber by way of the at least one gas supply line. In yet another embodiment, a use of a flotation machine as disclosed above is provided for separating out an ore contained in the suspension from gangue.

### BRIEF DESCRIPTION OF THE DRAWINGS

Example embodiments will be explained in more detail below with reference to figures, in which:

FIG. 1 shows a known dispersion nozzle for a flotation machine;

FIG. 2 shows a longitudinal section through the known dispersion nozzle according to FIG. 1;

FIG. 3 shows a suspension nozzle in longitudinal section with gas ducts which open out at the end face of the suspension nozzle, according to an example embodiment;

FIG. 4 shows the suspension nozzle according to FIG. 3, seen from below;

FIG. 5 shows a suspension nozzle in longitudinal section with devices which are able to induce the suspension into spiral-like rotation around a longitudinal central axis of the suspension nozzle, according to an example embodiment;

FIG. 6 shows the suspension nozzle according to FIG. 5 in a plan view;

FIG. 7 shows the suspension nozzle according to FIG. 5, seen from below;

FIG. 8 shows a dispersion nozzle for the device in longitudinal section, according to an example embodiment;

FIG. 9 shows a further dispersion nozzle for the device in longitudinal section, according to an example embodiment;

FIGS. 10 to 14 schematically show a method for operating a device comprising a suspension nozzle having N=8 gas ducts at a maximum gas supply rate, according to an example embodiment;

FIGS. 15 to 19 schematically show a method for operating a device comprising a suspension nozzle having N=8 gas ducts at a minimum gas supply rate, according to an example embodiment; and

FIG. 20 shows a flotation machine in longitudinal section, according to an example embodiment.

### DETAILED DESCRIPTION

Some embodiments provide a device which is improved in terms of the dispersion result from suspension and gas, said device comprising a dispersion nozzle, as well as to provide a method for its operation that is improved in that regard.

Further, some embodiments provide a flotation machine delivering a higher yield and to disclose a method for its operation.

In some embodiments, a device for dispersing a suspension containing at least one gas in that the device comprises a dispersion nozzle which, viewed in the flow direction of the suspension, successively includes
a suspension nozzle tapering in the flow direction;
a mixing chamber into which the suspension nozzle leads;
a mixing tube adjoining the mixing chamber and tapering in the flow direction; and
at least one gas supply line for feeding the at least one gas into the mixing chamber,

wherein the suspension nozzle has at least a number N≧3 of gas ducts connected to the at least one gas supply line and opening out at an end face of the suspension nozzle facing the mixing chamber, and wherein the device additionally has a number A of gas valves, where N=A, wherein a gas control valve for metering a gas volume of the gas supplied to the suspension through the respective gas duct is associated with each of the at least N gas ducts.

Feeding gas that is to be dispersed in the suspension in the region of the end face of the suspension nozzle results in a particularly homogeneous distribution of gas in the region of the surface of the developing open jet and a particularly large volume of gas being uniformly ingested into the open jet. By means of the device disclosed herein it may be possible to identify and select experimentally in minimum time particularly effective gassing patterns M for a specific suspension, for example based on an assessment of the resulting foam product when the device is used with a flotation machine. A gassing pattern M is understood in the present context to mean an injection of gas by way of specific individual gas ducts or groups of gas ducts, said gas injection varying in chronological sequence and being repeated in the sequence at specific time intervals.

A gas control valve of the device can be of such type as to enable a switchover to be made between different gases so that one and the same gas duct or one and the same group of gas ducts can be served with different types of gas.

The use of piezoelectronically controlled gas control valves may be particularly preferred, since these have open and close times in the region of a few milliseconds and optimally satisfy the high requirements to be fulfilled in terms of the realizable open and close times in the case of a device as disclosed herein.

The gas control valves are preferably controllable electronically by way of at least one central control unit. This enables the most disparate gassing patterns M to be set and implemented quickly and above all in an automated manner.

The device may be suitable in particular for general deployment with any type of flotation machine, preferably for use with pneumatic flotation machines. In this case a foam product improved in terms of volume formed and quality may be achieved owing to the attained higher collision probability between a gas bubble and a particle that is to be separated out. However, the device can also be used in other processes in which a suspension and at least one gas are to be dispersed.

It has proven beneficial, in order to increase the number of gas bubbles in the suspension even further, if in addition at least one pressure water conduit is present for injecting water containing a volume of gas dissolved therein, at least some of which gas escapes in the mixing chamber, into the suspension nozzle and/or into the mixing tube. The gas can be present in solution in the water up to the saturation limit of the gas. The water with gas dissolved therein may be preferably introduced into the interior of the dispersion nozzle at a point at which the water directly passes into the suspension or the suspension already dispersed with gas. Due to the drop in pressure occurring in the water at the transition between pressure water conduit and suspension, at least some of the gas dissolved therein escapes and forms micro gas bubbles which are dispersed in the suspension. Depending on the location of the suspension, a pressure in the range of 1 to 5 bar may be typically in effect inside a nozzle; this pressure, which must be overcome, can vary inside the nozzle or along the flow direction of the suspension in the nozzle.

A micro gas bubble is understood in this context to mean a gas bubble having a diameter of ≦100 μm. Such a micro bubble may be able to bind ultrafine particles of the suspension to itself and consequently significantly increase the yield of ultrafine particles in a flotation process.

In this case the at least one pressure water conduit can be routed through a wall of the suspension nozzle and/or the mixing tube. Alternatively, the at least one pressure water conduit can also be routed into the mixing chamber in order to open out at a point inside the mixing tube which adjoins a surface of an open jet developing from the end face of the suspension nozzle in the direction of the mixing tube and comprising the suspension. In both cases a feed-in site may be preferably to be chosen at which the water is injected directly into the suspension.

Preferably the suspension nozzle may be provided with at least one device which is able to induce the suspension into spiral-like rotation around a longitudinal central axis of the suspension nozzle. Owing to the rotational movement, which overlays the translational movement of the suspension through the dispersion nozzle, an enlarged suspension surface may be produced which comes into contact with the gas that is accordingly to be dispersed. As a result there may be an increase in the gas volume and the number of gas bubbles drawn into the suspension and their dispersion may be improved. Overall, there may be a substantial increase in the volume of gas ingested into the suspension as well as in the degree of dispersion in comparison with conventional dispersion nozzles.

It may be beneficial if the at least one device which is able to induce the suspension into spiral-like rotation around a longitudinal central axis of the suspension nozzle comprises at least one groove, arranged at an inside face of the suspension nozzle facing the suspension and extending in a spiral shape from a side of the suspension nozzle facing away from the mixing chamber to the end face of the suspension nozzle facing the mixing chamber. A groove of said type is often also referred to as a swirl groove. In this case the number and depth of such swirl grooves can be freely chosen within wide limits, depending on the dimension of the suspension nozzle. An optimal number and embodiment of the grooves, including in respect of their angle of inclination, which preferably lies in the range of 0 to 45°, can easily be ascertained experimentally.

In combination therewith or alternatively thereto, it has proven beneficial if the at least one device includes at least one ridge arranged at an inside face of the suspension nozzle facing the suspension and extending in a spiral shape from a side of the suspension nozzle facing away from the mixing chamber to the end face of the suspension nozzle facing the mixing chamber.

Alternatively to an embodiment as swirl grooves or ridges, the at least one device which is able to induce the suspension into spiral-like rotation around a longitudinal central axis of the suspension nozzle can also be formed by means of at least one spiral-shaped nozzle insert and the like or a combination of such a nozzle insert with swirl grooves and/or ridges.

In some embodiments of the device, a maximally large surface of the open jet is created as a contact surface with the gas and that the kinetic energy of the rotating open jet leads to an increased ingestion of gas into the suspension.

In an example embodiment, the suspension nozzle has at least a number N≧8 of gas ducts which open out at the end face of the suspension nozzle facing the mixing chamber. The number of gas ducts can be freely chosen within wide limits, depending on the dimension of the suspension nozzle. In order to vary the gas volume that is to be introduced into the suspension and the inflow velocity, an optimal number and embodiment of the gas ducts, including in terms of their diameter, may be easily ascertained experimentally.

In this case a symmetrical arrangement of the outlet ports of the gas ducts at the end face of the suspension nozzle has proven particularly beneficial for generating a maximally uniform distribution of gas in the mixing chamber. Viewed in the direction of the end face of the suspension nozzle, the N gas ducts are in this case preferably arranged centered at a uniform distance from one another on at least one circular path around the longitudinal central axis of the suspension nozzle.

Some embodiments provide a method for operating a device comprising a dispersion nozzle and in addition gas control valves, in that the gas control valves associated with the at least N gas ducts are operated in a clocked mode such that at any given instant in time at least one gas control valve is closed and at least one further gas control valve is open, the gas supply fed to the suspension being interrupted temporarily at each gas control valve in accordance with a gassing pattern M.

In this context a gassing pattern M is understood to mean, as already explained above, an injection of gas by way of specific individual gas ducts or groups of gas ducts, said gas injection varying in chronological sequence and being repeated in the sequence at specific time intervals. Particularly effective gassing patterns M for a specific suspension can be identified and chosen here experimentally in minimum time, for example based on an assessment of the resulting foam product when the method is used in a flotation machine.

It may be advantageous in particular if the gas control valves are regulated for supplying a maximum volume of gas to the suspension in such a way that at any given instant in time only one gas duct is closed, the gas supply to the suspension being interrupted temporarily at each of the gas ducts in turn in accordance with a first gassing pattern Ml. This promotes the uniform ingestion of the gas into the suspension and its distribution therein.

Further, it may be beneficial for a minimum gas supply rate to the suspension to regulate the gas control valves in such a way that at any given instant in time only one gas duct is open, the gas being supplied to the suspension temporarily and through each of the gas ducts in turn in accordance with a second gassing pattern M2. This reliably prevents gas ducts being blocked by particles of the suspension even at low gas supply rates.

The second gassing pattern M2 may be preferably embodied such that, viewed in the direction of the end face of the suspension nozzle, the at least one gas is supplied successively through gas ducts arranged adjacent to one another. The gas may be injected by way of gas ducts which succeed one another in the clockwise or anticlockwise direction, since this leads to a homogenization of the dispersion process.

In an alternative manner the gassing pattern M may be embodied such that, viewed in the direction of the end face of the suspension nozzle, the at least one gas is supplied through adjacent groups of gas ducts arranged adjacent to one another in turn. This can be used for a further homogenization of the dispersion process. In this case the gas supply can be regulated by way of two or more gas ducts simultaneously by means of a single gas control valve or by means of one gas control valve per gas duct in each case.

It has proved beneficial to supply a subset of the N gas ducts with a first gas by way of a first gas supply line and the remainder of the gas ducts with a second gas that is different from the first gas by way of a second gas supply line. It is possible for different gases, such as air and nitrogen for example, to be used here, although other gases can also be employed.

Some embodiments provide a foam product that is improved in terms of volume formed and quantity is achieved owing to the attained higher collision probability between a gas bubble and a particle that is to be separated out. The yield rate of particles to be discharged may be effectively increased.

The flotation machine preferably comprises a housing having a flotation chamber into which leads the dispersion nozzle of the at least one device, as well as at least one gas injection arrangement for further feeding of gas into the flotation chamber and arranged in the flotation chamber below the dispersion nozzle(s).

The flotation machine can also have a different design, however.

A use of a flotation machine according to embodiments disclosed herein for separating out an ore contained in the suspension from gangue may be beneficial, since a particularly effective yield of the ore may be obtained.

Some embodiments provide a method for operating a flotation machine wherein the suspension is injected into the flotation chamber by means of the dispersion nozzle and the device is operated according to embodiments disclosed herein, wherein gas is supplied to the mixing chamber by way of the at least one gas supply line, wherein the gas control valves associated with the at least N gas ducts are operated in a clocked mode, wherein at any given instant in time at least one gas control valve is closed and at least one further gas control valve is open, and wherein the gas supply to the suspension is interrupted temporarily at each gas control valve in accordance with a gassing pattern M.

Accordingly, a further increase in the yield from the flotation machine can be achieved by targeted choice of a mode of operation of the device according to embodiments disclosed herein.

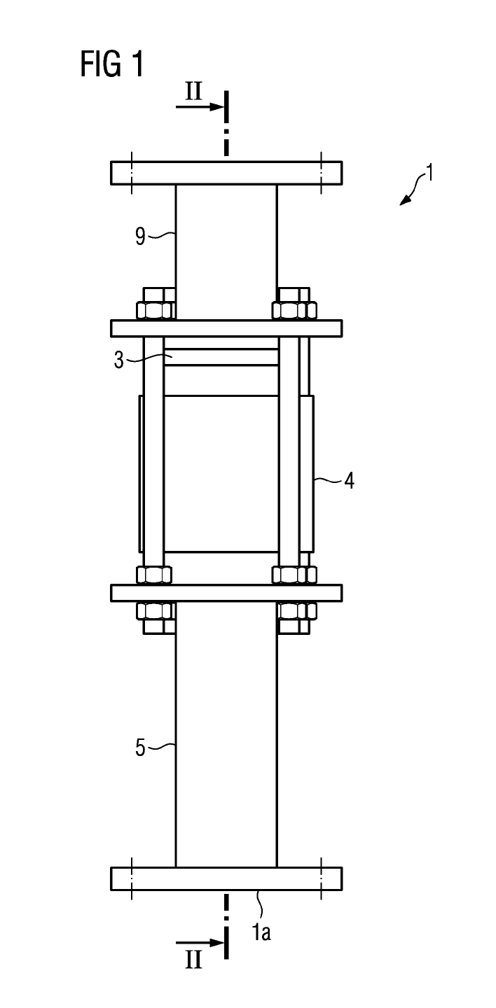

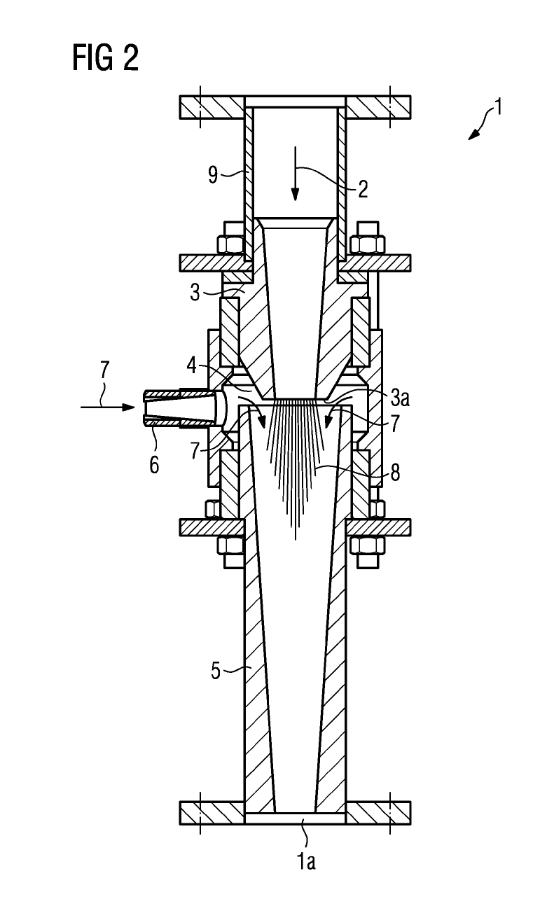

A known dispersion nozzle for a flotation machine, as shown in FIGS. 1 and 2, is explained above in the Background section.

In contrast thereto, a dispersion nozzle for a device according to certain embodiments may be equipped with a suspension nozzle which has at least N=3 gas ducts connected to the at least one gas supply line which opens out at an end face of the suspension nozzle facing the mixing chamber.

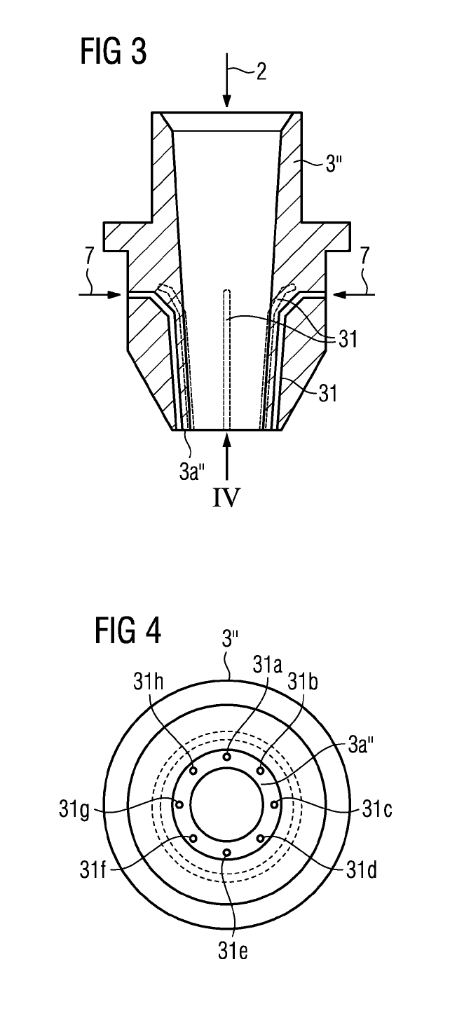

FIG. 3 shows a possible suspension nozzle 3″ for a dispersion nozzle of a device according to an example embodiment in longitudinal section having gas ducts 31 which open out at the end face 3a″ of the suspension nozzle 3″. The gas 7 is introduced by way of the gas ducts 31, released at the end face 3a″ of the suspension nozzle 3″ and dispersed with the suspension 2.

FIG. 4 shows the suspension nozzle 3″ according to FIG. 3 from below, revealing the end face 3a″ of the suspension nozzle 3″ with a total of N=8 gas ducts 31 or, specifically, 31a, 31b, 31c, 31d, 31e, 31f, 31g, 31h, opening out there. The center points of the eight gas ducts 31 lie on a circular line, the circle being arranged centered with respect to the center of the suspension nozzle 3″.

The suspension nozzle 3″ according to FIGS. 3 and 4 cannot be used as a direct replacement for a suspension nozzle 3 of a conventional dispersion nozzle 1 in order to obtain a dispersion nozzle suitable for the device. Rather, an appropriate connection of the individual gas ducts 31 to one or more gas supply lines 6a, 6b may be required in this case, though this can be realized without difficulty by a person skilled in the art.

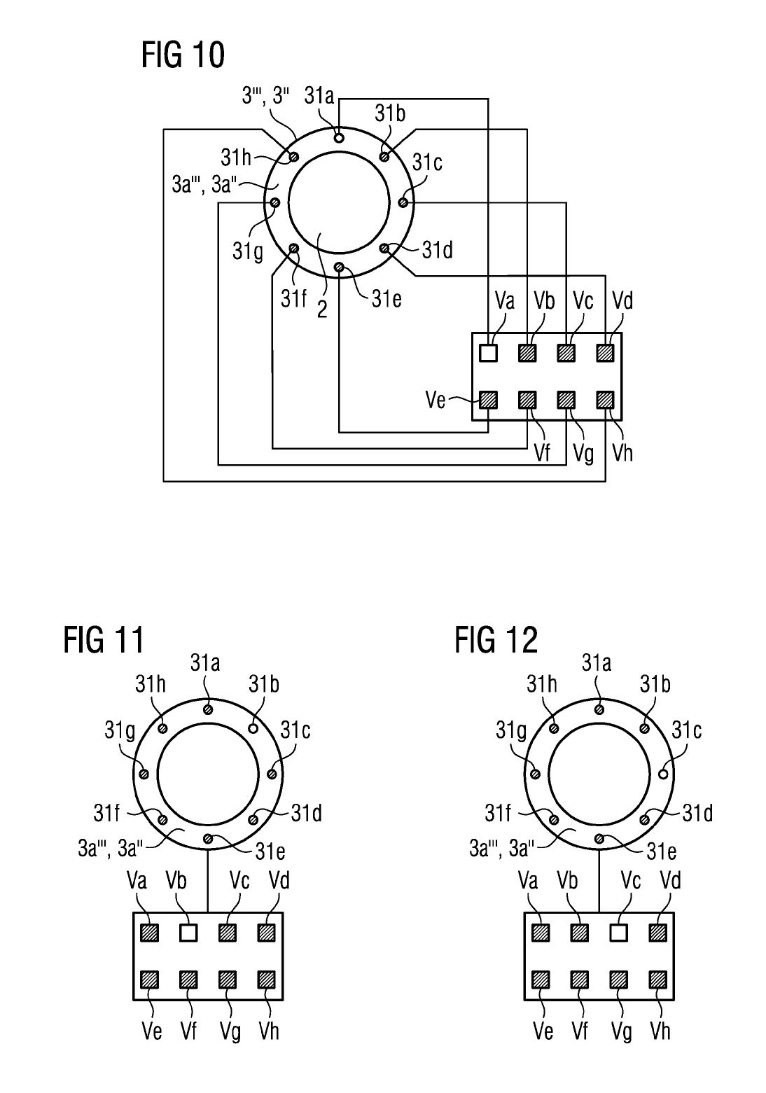

The eight gas ducts 31 enable a gas 7 to be introduced into the suspension 2 in a targeted manner in terms of gas volume and/or location of the injection and/or distribution of the injection. The gas ducts 31 are supplied individually with gas 7 and are each connected to a gas control valve Va, Vb, Vc, Vd, Ve, Vf, Vg, Vh (compare in this regard FIGS. 10 to 19). Accordingly, a specific gassing pattern M can be set by means of the eight gas ducts 31. A gassing pattern M is understood in this context to mean an injection of gas 7 by way of specific individual gas ducts 31 or groups of gas ducts 31, said injection of gas varying in chronological sequence and being repeated at specific time intervals in the sequence,. This is explained in more detail below with reference to FIGS. 10 to 19.

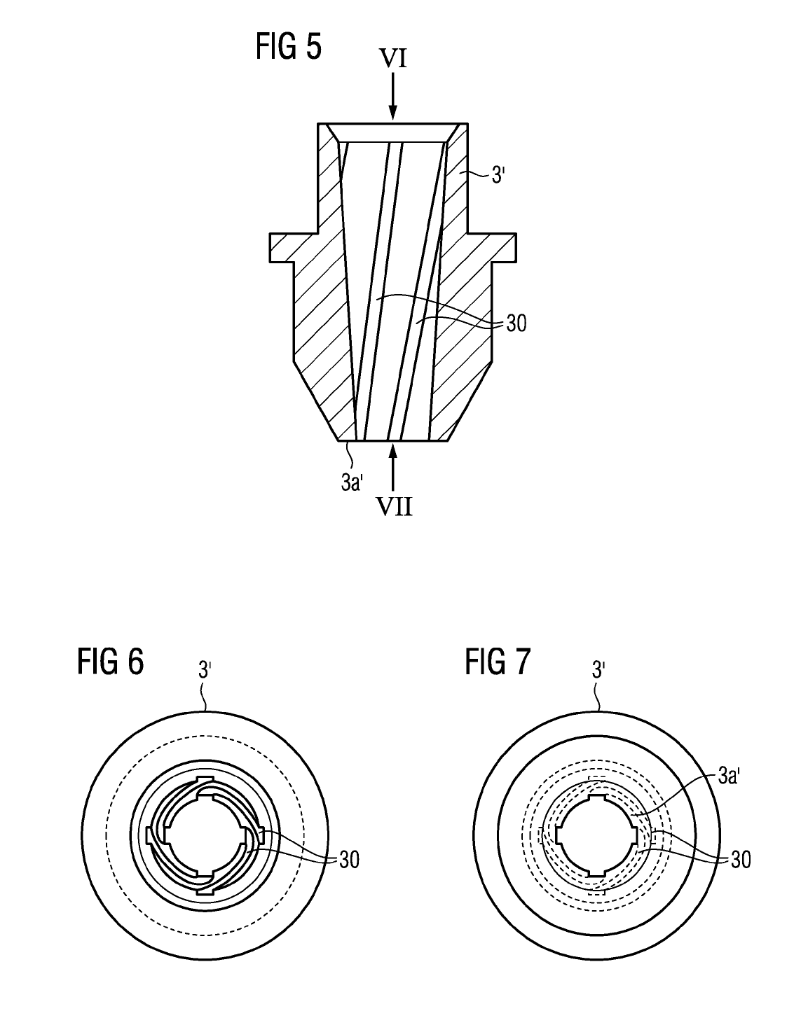

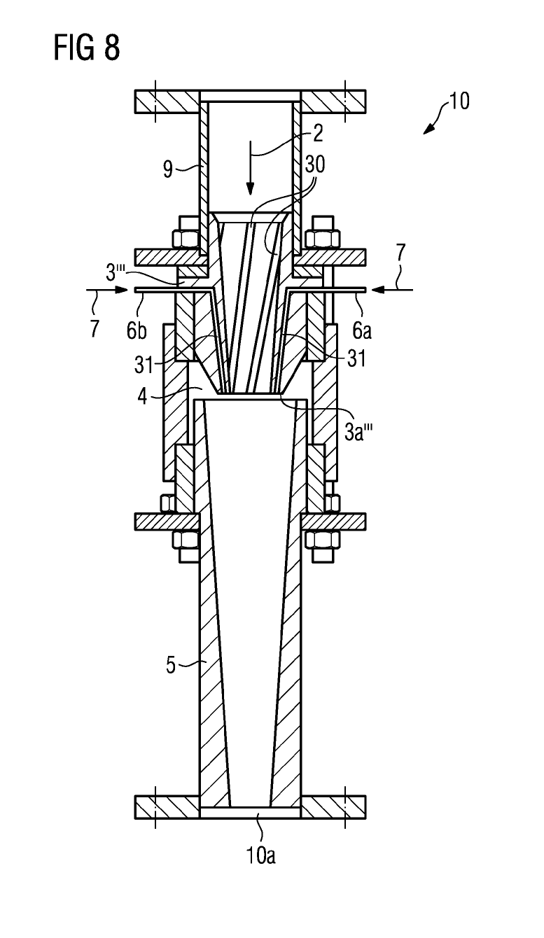

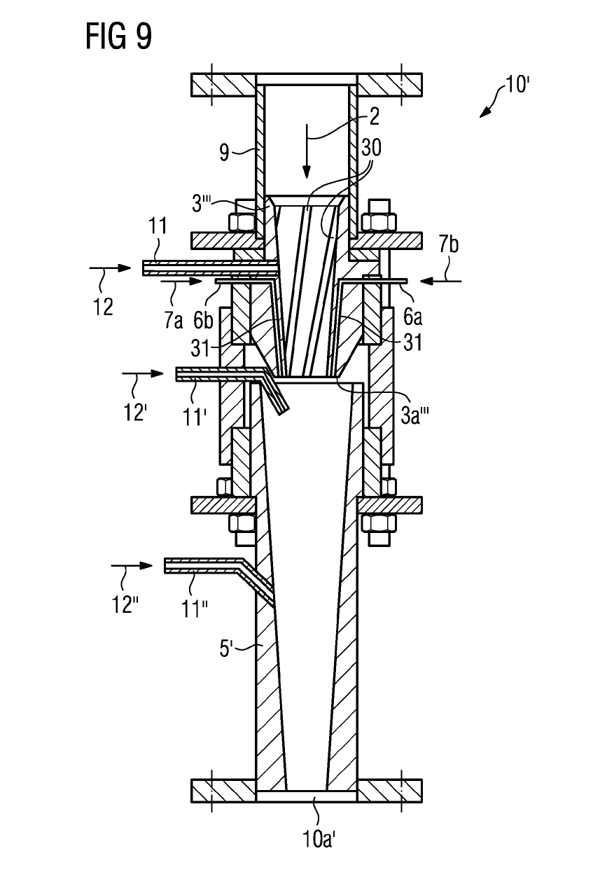

FIG. 5 shows a preferred embodiment of the suspension nozzle 3′ for a dispersion nozzle in longitudinal section, this being equipped with devices 30 which are able to induce the suspension 2 (see also FIGS. 8 and 9) into spiral-like rotation around a longitudinal central axis of the suspension nozzle 3′. For clarity of illustration reasons the requisite gas ducts 31 have been omitted from this diagram. The devices 30 are implemented as spiral-shaped grooves, also referred to as swirl grooves, which are arranged at the inner wall of the suspension nozzle 3′. Alternatively to an embodiment as swirl grooves, however, the devices 30 can also be formed by ridges, spiral-shaped inserts and the like or by a combination of such devices, where appropriate also in combination with swirl grooves. The number, depth and angle of inclination of the grooves are in this case freely selectable within wide limits and are constrained solely by the dimensions and the material of the suspension nozzle used.

FIG. 6 shows the suspension nozzle 3′ (without gas ducts) according to FIG. 5 in a plan view, revealing the profile of the four swirl grooves present at the inner wall of the suspension nozzle 3′.

FIG. 7 shows the suspension nozzle 3′ (without gas ducts) according to FIG. 5 from below, revealing the end face 3a′ of the suspension nozzle 3′ with the swirl grooves, at which end face the suspension 2 induced into rotation (see also FIGS. 8 and 9) emerges from the suspension nozzle 3′.

A more intimate mixing of gas 7 and suspension 2 takes place in the mixing chamber 4 owing to the suspension 2 being induced into rotation in the suspension nozzle 3′. As a result an improved degree of dispersion of gas 7 and suspension 2 may be achieved at the outlet of the dispersion nozzle.

FIG. 8 shows a dispersion nozzle 10 for a device in longitudinal section, the device being equipped with a suspension nozzle 3′″ which shows the gas ducts 31 and has the devices 30 in the form of swirl grooves, as shown in FIGS. 5 to 7.

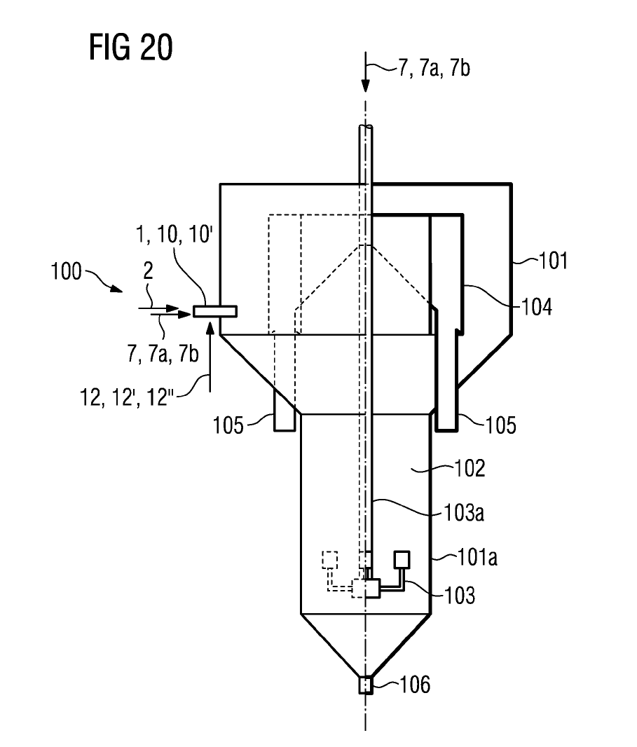

The dispersion nozzle 10 may be suitable in particular for use in the device and consequently for use for flotation machines or hybrid flotation cells (see FIG. 20). The longitudinal section through the dispersion nozzle 10 shows the flow profile of suspension 2 and gas 7 in each case. Viewed in the flow direction (see direction of arrow) of the suspension 2, the dispersion nozzle 10 successively comprises the suspension nozzle 3′″ tapering in the flow direction, a mixing chamber 4 into which the suspension nozzle 3′″ leads, a mixing tube 5 adjoining the mixing chamber 4 and tapering in the flow direction, and at least one gas supply line 6a, 6b for supplying at least one gas 7 by way of the gas ducts 31 into the mixing chamber 4. The suspension 2 may be injected into the suspension nozzle 3′″ by way of an adapter fitting 9 and enters the mixing chamber 4 at the end face 3a′″ of the suspension nozzle 3′″ as an open jet rotating around the longitudinal central axis of the suspension nozzle 3′″ (compare FIG. 2). The gas 7 injected in a clocked mode into the mixing chamber 4 by way of the gas ducts 31 may be mixed with the suspension 2 emerging from the suspension nozzle 3′″. Gas 7 and suspension 2 pass into the mixing tube 5, where a further intensive dispersion takes place. A suspension 2 with gas 7 particularly finely and intimately dispersed therein is present at the outlet port 10a from the dispersion nozzle 10.

FIG. 9 shows a further dispersion nozzle 10′ for a device in longitudinal section, which device may be likewise equipped with a suspension nozzle 3′″ as already shown in principle in FIG. 8.

The dispersion nozzle 10′ likewise may be suitable in particular for use in flotation machines or hybrid flotation cells (see FIG. 20). The longitudinal section through the dispersion nozzle 10′ shows the flow profile of suspension 2 and gas 7a, 7b in each case. The dispersion nozzle 10′ may be in principle structured in the same way as the dispersion nozzle 10 according to FIG. 8. In this case, however, different gases 7a, 7b, air and nitrogen for example, are injected into the gas ducts 31 by way of the gas supply lines 6a, 6b.

In further contrast to the dispersion nozzle 10 according to FIG. 8, the dispersion nozzle 10′ has at least one pressure water conduit 11, 11′, 11″ which injects water 12, 12′, 12″ containing gas dissolved under pressure therein into the suspension 2. Viewed in the flow direction (see direction of arrow) of the suspension 2, said water 12 may be injected in particular already in the region of the suspension nozzle 3′″, i.e. before the suspension 2 enters the mixing chamber 4. For this purpose a pressure water conduit 11 may be routed through the suspension nozzle 3′″. Alternatively thereto or in combination therewith, however, said water 12′, 12″ can also be injected in the mixing tube 5′. In this case it has proven beneficial to inject the water into the mixing tube 5′ either directly in the region of the surface of the developing open jet (compare FIG. 2), in which case a pressure water conduit 11′ may be routed into the mixing tube 5′ by way of the mixing chamber 4 and/or the pressure water conduit 12″ may be routed through the wall of the mixing tube 5′.

After the water 12, 12′, 12″ enters the suspension nozzle 3″' or the mixing tube 5′, in which a lower pressure prevails than in the respective pressure water conduit 11, 11′, 11″, the gas dissolved under pressure in the water 12, 12′, 12″ escapes and forms micro gas bubbles which are intimately dispersed with the suspension 2.

A water-diluted suspension 2 containing gas 7a, 7b particularly finely and intimately dispersed therein and micro gas bubbles is present at the outlet port 10a′ from the dispersion nozzle 10′.

FIGS. 10 to 14 are schematic representations intended to explain a method according to an example embodiment for operating a device, of which, in order to provide a better overview, only the suspension nozzle 3″, 3′″ with N=8 gas ducts 31 and the associated gas control valves Va, Vb, Vc, Vd, Ve, Vf, Vg, Vh are schematically shown here to represent the dispersion nozzle 10, 10′, at a maximum gas supply rate of gas 7, 7a, 7b. The maximum gas supply rate may be effected simultaneously by way of seven of the eight gas ducts 31 present, which of the eight gas ducts being closed varying over time.

FIG. 10 shows the end face of a suspension nozzle 3″, 3′″ of a dispersion nozzle 10, 10′ of the device according to an example embodiment with N=8 gas ducts 31 or, specifically, 31a, 31b, 31c, 31d, 31e, 31f, 31g, 31h. The precise number of gas ducts 31 is not limiting here, however. There can, of course, also be more or fewer gas ducts 31 present. In this case each gas duct 31 is controlled by means of a gas control valve V.

The gas duct 31a may be connected to a gas control valve Va which regulates a gas supply rate of the gas 7, 7a, 7b (compare FIGS. 8 and 9) into the gas duct 31a. The gas duct 31b may be connected to a gas control valve Vb which regulates a gas supply rate of the gas 7, 7a, 7b into the gas duct 31b. The gas duct 31c may be connected to a gas control valve Vc which regulates a gas supply rate of the gas 7, 7a, 7b into the gas duct 31c. The gas duct 31d may be connected to a gas control valve Vd which regulates a gas supply rate of the gas 7, 7a, 7b into the gas duct 31d. The gas duct 31e may be connected to a gas control valve Ve which regulates a gas supply rate of the gas 7, 7a, 7b into the gas duct 31e. The gas duct 31f may be connected to a gas control valve Vf which regulates a gas supply rate of the gas 7, 7a, 7b into the gas duct 31f. The gas duct 31g may be connected to a gas control valve Vg which regulates a gas supply rate of the gas 7, 7a, 7b into the gas duct 31g. The gas duct 31h may be connected to a gas control valve Vh which regulates a gas supply rate of the gas 7, 7a, 7b into the gas duct 31h. The gas control valves V are preferably controllable electronically by way of a central control unit.

According to FIG. 10, only the gas control valve Va, and hence the gas duct 31a, is closed in this arrangement, such that no gas 7, 7a, 7b emerges here. The remaining gas control valves Vb, Vc, Vd, Ve, Vf, Vg, Vh, and hence also the gas ducts 31b, 31c, 31d, 31e, 31f, 31g, 31h, are open and enable the gas 7, 7a, 7b to enter the mixing chamber (not shown in the figure). However, in order to achieve an optimal dispersion of suspension 2 flowing through the suspension nozzle 3″, 3′″ with the gas 7, 7a, 7b, the valve setting according to FIG. 10 may be maintained only over a specific time interval, the optimal length of which needs to be ascertained experimentally, and then changed.

In this case a first gassing pattern M1 may be chosen in which the gas ducts 31a to 31h or, as the case may be, the valves Va to Vh associated therewith are switched off individually in turn in the clockwise direction at constant time intervals. FIG. 10 accordingly shows the first stage of the first gassing pattern M1.

FIG. 11 shows the second stage of the first gassing pattern M1 following after a time interval, in this case of e.g. 1s. Starting from the valve setting according to FIG. 10, the gas control valve Va has been closed and the gas control valve Vb, which may be connected upstream of the gas duct 31b adjacent to the gas duct 31a in the clockwise direction, has been opened simultaneously. The remaining gas control valves Vc to Vh continue to stay open as before.

FIG. 12 shows the third stage of the first gassing pattern M1 following after a time interval, in this case of e.g. 1s. Starting from the valve setting according to FIG. 11, the gas control valve Vb has been closed and the gas control valve Vc, which may be connected upstream of the gas duct 31c adjacent to the gas duct 31b in the clockwise direction, has been opened simultaneously. The following remaining gas control valves Vd to Va continue to stay open as before.

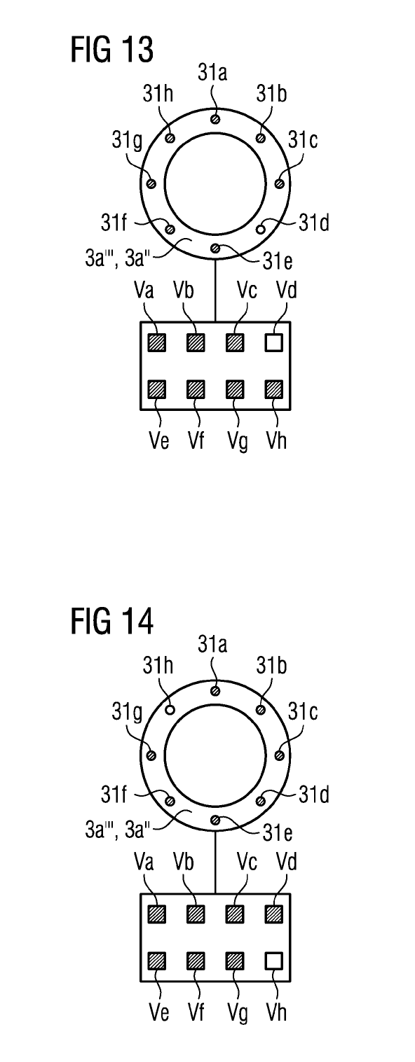

FIG. 13 shows the fourth stage of the first gassing pattern M1 following after a time interval, in this case of e.g. 1s. Starting from the valve setting according to FIG. 12, the gas control valve Vc has been closed and the gas control valve Vd, which may be connected upstream of the gas duct 31d adjacent to the gas duct 31c in the clockwise direction, has been opened simultaneously. The following remaining gas control valves Ve to Vb continue to stay open as before.

In the fifth to seventh stages (not shown separately) that are to be performed analogously, the gas duct which is closed moves on further in the clockwise direction per time interval, such that the gas control valve Ve, Vf, Vg alone is closed in each case in turn per time interval.

FIG. 14 shows the eighth stage of the first gassing pattern M1 following after a further time interval, in this case of e.g. 1s. Starting from the valve setting according to the seventh stage, the gas control valve Vg has been closed and the gas control valve Vh, which may be connected upstream of the gas duct 31h adjacent to the gas duct 31g in the clockwise direction, has been opened simultaneously. The following remaining gas control valves Va to Vf continue to stay open as before.

The first gassing pattern Ml, which, viewed onto the end face 3a″, 3a′″ of the suspension nozzle 3″, 3′″, shows a closed gas duct circulating in the clockwise direction, is now complete and may be repeated. The stage now following may be identical to the first stage according to FIG. 10. The first to eighth stages are now continually repeated in sequence per time interval until a modified gassing pattern M is desired.

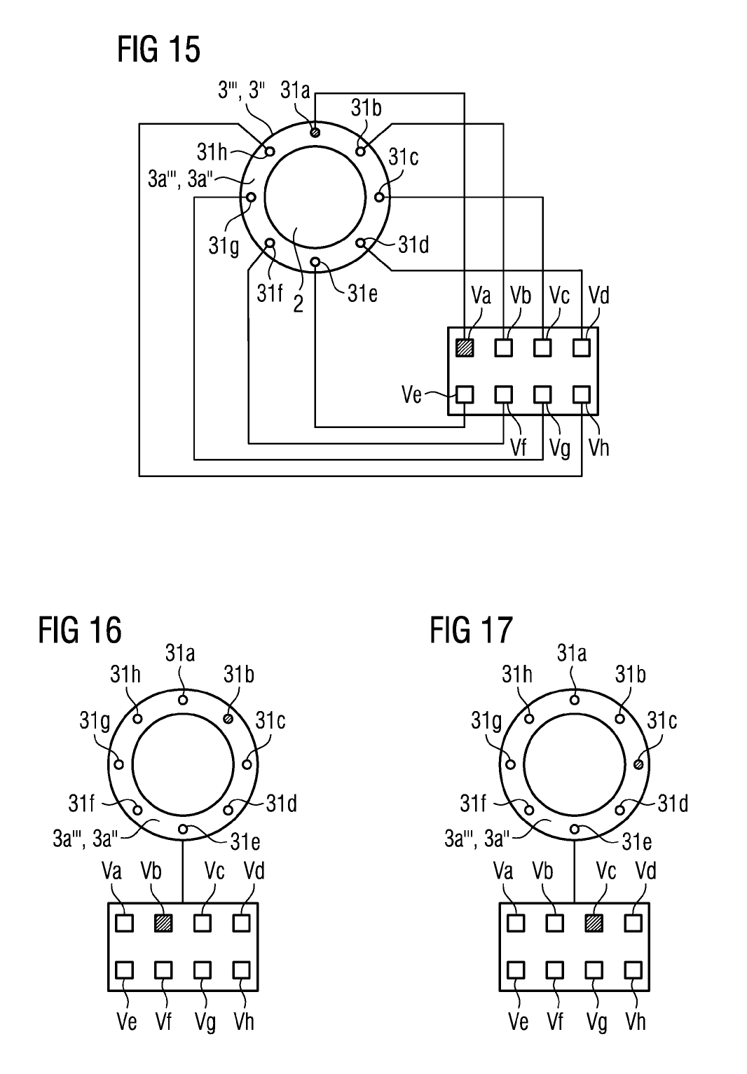

FIGS. 15 to 19 are schematic representations intended to explain a preferred method for operating a device according to an example embodiment having a dispersion nozzle 10, 10′ comprising a suspension nozzle 3″, 3′″ with N=8 gas ducts 31 at a minimum gas supply rate.

Here too, the precise number of gas ducts 31 is not limiting. It is, of course, also possible for more or fewer gas ducts 31 to be present.

According to FIG. 15, only the gas control valve Va, and hence the gas duct 31a, is open in this case, with the result that gas 7, 7a, 7b exits at this point only. The remaining gas control valves Vb, Vc, Vd, Ve, Vf, Vg, Vh, and hence also the gas ducts 31b, 31c, 31d, 31e, 31f, 31g, 31h, are closed and allow no entry of the gases 7, 7a, 7b into the mixing chamber (not shown here). However, in order to achieve an optimal dispersion of suspension 2 flowing through the suspension nozzle 3″, 3′″ with the minimum volume of gas 7, 7a, 7b, the valve setting according to FIG. 15 is maintained only over a specific time interval, the optimal length of which needs to be ascertained experimentally, and then changed.

In this case a second gassing pattern M2 may be chosen in which the gas ducts 31a to 31h or, as the case may be, the valves Va to Vh associated therewith are switched off individually in turn in the clockwise direction at constant time intervals. FIG. 15 accordingly shows the first stage of the second gassing pattern M2.

FIG. 16 shows the second stage of the second gassing pattern M2 following after a time interval, in this case of e.g. 1s. Starting from the valve setting according to FIG. 15, the gas control valve Va has been closed and the gas control valve Vb, which may be connected upstream of the gas duct 31b adjacent to the gas duct 31a in the clockwise direction, has been opened simultaneously. The remaining gas control valves Vc to Vh continue to stay closed as before.

FIG. 17 shows the third stage of the second gassing pattern M2 following after a time interval, in this case of e.g. 1s. Starting from the valve setting according to FIG. 16, the gas control valve Vb has been closed and the gas control valve Vc, which may be connected upstream of the gas duct 31c adjacent to the gas duct 31b in the clockwise direction, has been opened simultaneously. The following remaining gas control valves Vd to Va continue to stay closed as before.

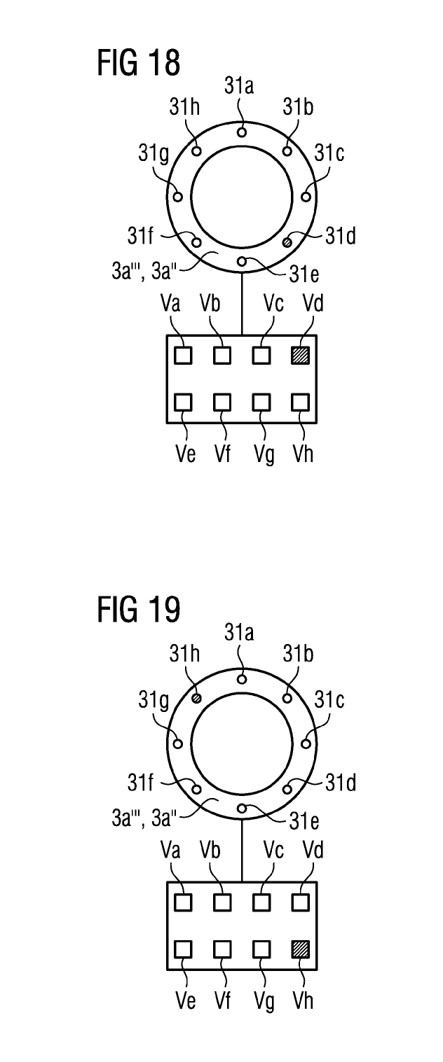

FIG. 18 shows the fourth stage of the second gassing pattern M2 following after a time interval, in this case of e.g. 1s. Starting from the valve setting according to FIG. 17, the gas control valve Vc has been closed and the gas control valve Vd, which may be connected upstream of the gas duct 31d adjacent to the gas duct 31c in the clockwise direction, has been opened simultaneously. The following remaining gas control valves Ve to Vb continue to stay closed as before.

In the fifth to seventh stages (not shown separately) that are to be performed analogously, the gas duct which is open moves on further in the clockwise direction per time interval, such that the gas control valve Ve, Vf, Vg alone is open in each case in turn per time interval.

FIG. 19 shows the eighth stage of the second gassing pattern M2 following after a further time interval, in this case of e.g. 1s. Starting from the valve setting according to the seventh stage, the gas control valve Vg has been closed and the gas control valve Vh, which may be connected upstream of the gas duct 31h adjacent to the gas duct 31g in the clockwise direction, has been opened simultaneously. The following remaining gas control valves Va to Vf continue to stay closed as before.

The second gassing pattern M2, which, viewed onto the end face 3a″, 3a′″ of the suspension nozzle 3″, 3′″, shows an open gas duct 31 circulating in the clockwise direction, is now complete and may be repeated. The stage now following may be identical to the first stage according to FIG. 15. The first to eighth stages are now continually repeated in sequence per time interval until a modified gassing pattern M is desired.

A multiplicity of different gassing patterns M can be chosen here which diverge from the first gassing pattern M1 and second gassing pattern M2 explained here in detail. Below are listed just a few examples of further possible gassing patterns M:

Third Gassing Pattern M3:

Two gas ducts are always open simultaneously, where the following applies:

Stage 1: Va, Vb open; Vc to Vh closed;

Stage 2: Vb, Vc open; Vd to Va closed;

Stage 3: Vc, Vd open; Ve to Vb closed;

Stage 4: Vd, Ve open; Vf to Vc closed;

Stage 5: Ve, Vf open; Vg to Vd closed;

Stage 6: Vf, Vg open; Vh to Ve closed;

Stage 7: Vg, Vh open; Va to Vf closed;

Stage 8: Vh, Va open; Vb to Vg closed.

The third gassing pattern M3 is then repeated.

Fourth Gassing Pattern M4:

Two gas ducts are always open simultaneously, where the following applies:

Stage 1: Va, Ve open; Vb to Vd and Vf to Vh closed;

Stage 2: Vb, Vf open; Vc to Ve and Vg to Va closed;

Stage 3: Vc, Vg open; Vd to Vf and Vh to Vb closed;

Stage 4: Vd, Vh open; Ve to Vg and Va to Vc closed.

The fourth gassing pattern M4 is then repeated.

Fifth Gassing Pattern M5:

Four gas ducts are always open simultaneously, where the following applies:

Stage 1: Va, Vc, Ve, Vg open; Vb, Vd, Vf, Vh closed;

Stage 2: Vb, Vd, Vf, Vh open; Va, Vc, Ve, Vg closed.

The fifth gassing pattern M5 is then repeated.

In this case the gassing pattern M5 can be varied further in that different gases are injected in stage 1 and stage 2, for example in the form of air in stage 1 and in the form of nitrogen in stage 2.

Sixth Gassing Pattern M6:

Only one gas duct is open at any given time, where the following applies:

Stage 1: Va open; Vb to Vh closed;

Stage 2: Vb open; Vc to Va closed;

Stage 3: Vf open; Vg to Ve closed;

Stage 4: Vg open; Vh to Vf closed;

Stage 5: Vc open; Vd to Vb closed;

Stage 6: Vd open; Ve to Vc closed;

Stage 7: Vh open; Va to Vg closed;

Stage 8: Va open; Vb to Vh closed;

Stage 9: Ve open; Vf to Vd closed;

Stage 10: Vf open; Vg to Ve closed;

Stage 11: Vb open; Vc to Va closed;

Stage 12: Vc open; Vd to Vb closed;

Stage 13: Vg open; Vh to Vf closed;

Stage 14: Vh open; Va to Vg closed;

Stage 15: Vd open; Ve to Vb closed;

Stage 16: Ve open; Vf to Vd closed.

The sixth gassing pattern M6 is then repeated.

A multiplicity of further gassing patterns M are possible, depending on the chosen number of gas ducts and/or sequence of gas ducts for supplying gas and/or the gas ducts used simultaneously for supplying gas and/or the choice of the gas injected by way of a gas duct, in order to influence a volume and distribution of at least one gas in the suspension 2 and consequently the dispersion result.

Referring to FIG. 20, which is explained above in the Background section, a flotation machine 100 is shown in longitudinal section. As a result of using at least one device as described herein, wherein the dispersion nozzle 10, 10′ of the device leads into the flotation chamber 102 of the flotation machine 100, the dispersion of suspension and gas is improved, given the same or a similar installation position of the dispersion nozzle 10, 10′, and consequently the collision probability between a gas bubble and a particle to be separated out of the suspension 2 is increased. Increased separation rates and an optimal foam product can be achieved as a result.

However, the use of the device as disclosed herein is not limited to a flotation machine in general or to a flotation machine having a design according to FIG. 20. A device as disclosed herein comprising a dispersion nozzle and gas control valves can be deployed in flotation systems of any design or in installations in which at least one gas is to be finely and uniformly distributed in a suspension.

What is claimed is:

1. A device for dispersing a suspension containing at least one gas, said device comprising a dispersion nozzle which, viewed in the flow direction of the suspension, successively comprises:
a suspension nozzle tapering in the flow direction;
a mixing chamber into which the suspension nozzle leads;
a mixing tube adjoining the mixing chamber and tapering in the flow direction, and
at least one gas supply line for feeding the at least one gas into the mixing chamber, wherein the suspension nozzle has at least a number N≧3 of gas ducts connected to the at least one gas supply line, said gas ducts opening out at an end face of the suspension nozzle facing the mixing chamber,
wherein the device additionally has a number A of gas valves, where N=A, wherein one gas control valve for metering a gas volume of the gas supplied to the suspension through the respective gas duct is associated with each of the at least N gas ducts.

2. The device of claim 1, wherein at least one pressure water conduit is present for injecting water containing a volume of gas dissolved therein, at least some of which gas escapes in the mixing chamber, into the suspension nozzle and/or into the mixing tube.

3. The device of claim 2, wherein the at least one pressure water conduit is routed through a wall of the suspension nozzle and/or of the mixing tube.

4. The device of claim 2, wherein the at least one pressure water conduit is routed into the mixing chamber and opens out at a point inside the mixing tube which adjoins a surface of an open jet developing from the end face of the suspension nozzle in the direction of the mixing tube and comprising the suspension.

5. The device of claim 1, wherein the suspension nozzle is provided with at least one device which is able to induce the suspension into spiral-like rotation around a longitudinal central axis of the suspension nozzle.

6. The device of claim 5, wherein the at least one device comprises at least one groove which is arranged at an inside face of the suspension nozzle facing the suspension and which extends in a spiral shape from a side of the suspension nozzle facing away from the mixing chamber to the end face of the suspension nozzle facing the mixing chamber.

7. The device of claim 5, wherein the at least one device comprises at least one ridge which is arranged at an inside face of the suspension nozzle facing the suspension and which extends in a spiral shape from a side of the suspension nozzle facing away from the mixing chamber to the end face of the suspension nozzle facing the mixing chamber.

8. The device of claim 1, wherein the suspension nozzle has at least a number N≧8 of gas ducts.

9. The device of claim 1, wherein, viewed in the direction of the end face of the suspension nozzle, the N gas ducts are arranged centered at a uniform distance from one another on at least one circular path around the longitudinal central axis of the suspension nozzle.

10. A method for operating a device comprising a dispersion nozzle which, viewed in the flow direction of the suspension, successively comprises:
a suspension nozzle tapering in the flow direction;
a mixing chamber into which the suspension nozzle leads;
a mixing tube adjoining the mixing chamber and tapering in the flow direction, and
at least one gas supply line for feeding the at least one gas into the mixing chamber, wherein the suspension nozzle has at least a number N≧3 of gas ducts connected to the at least one gas supply line, said gas ducts opening out at an end face of the suspension nozzle facing the mixing chamber,
wherein the device additionally has a number A of gas valves, where N=A, wherein one gas control valve for metering a gas volume of the gas supplied to the suspension through the respective gas duct is associated with each of the at least N gas ducts,
the method comprising operating gas control valves associated with the at least N gas ducts in a clocked mode in such a way that at any given instant in time at least one gas duct is closed and at least one further gas duct is open, the gas supply to the suspension being interrupted temporarily at each gas duct in accordance with a gassing pattern M.

11. The method as claimed in claim 10, comprising regulating the gas control valves for supplying a maximum volume of gas to the suspension in such a way that only one gas duct is closed at any given instant in time, the gas supply to the suspension being temporarily interrupted at each of the gas ducts in turn in accordance with a first gassing pattern M1.

12. The method as claimed in claim 11, comprising regulating the gas control valves for supplying a minimum volume of gas to the suspension in such a way that only one gas duct is open at any given instant in time, the gas being supplied to the suspension temporarily through each gas duct in turn in accordance with a second gassing pattern M2.

13. The method as claimed in claim 12, wherein the second gassing pattern M2 is embodied in such a way that, viewed in the direction of the end face of the suspension nozzle, the at least one gas is supplied in turn through gas ducts arranged adjacent to one another.

14. The method as claimed in claim 10, wherein the gassing pattern M is embodied in such a way that, viewed in the direction of the end face of the suspension nozzle, the at least one gas is supplied in turn through adjacent groups of gas ducts arranged adjacent to one another.

15. The method as claimed in claim 10, comprising regulating supplying a subset of the N gas ducts with a first gas by way of a first gas supply line and supplying the remaining gas ducts by way of a second gas supply line with a second gas that is different from the first gas.

16. A flotation machine comprising:
at least one device for dispersing a suspension containing at least one gas, each devide including a dispersion nozzle which, viewed in the flow direction of the suspension, successively comprises:
a suspension nozzle tapering in the flow direction;
a mixing chamber into which the suspension nozzle leads;
a mixing tube adjoining the mixing chamber and tapering in the flow direction, and
at least one gas supply line for feeding the at least one gas into the mixing chamber, wherein the suspension nozzle has at least a number N≧3 of gas ducts connected to the at least one gas supply line, said gas ducts opening out at an end face of the suspension nozzle facing the mixing chamber,
wherein the device additionally has a number A of gas valves, where N=A, wherein one gas control valve for metering a gas volume of the gas supplied to the suspension through the respective gas duct is associated with each of the at least N gas ducts.

17. The flotation machine as claimed in claim 16, further comprising a housing having a flotation chamber into which leads the dispersion nozzle of the at least one device, as well as at least one gas injection arrangement for further feeding of gas into the flotation chamber and arranged in the flotation chamber below the dispersion nozzle(s).

18-19. (canceled)
